(19) United States
(12) Patent Application Publication
(10) Pub. No.: US 2020/0142486 A1
(43) Pub. Date: May 7, 2020

(54) FORCE FEEDBACK METHOD AND SYSTEM USING DENSITY

(71) Applicant: REALGAM CO., LTD., Seongnam-Si, Gyeonggi-do (KR)

(72) Inventors: Bok Sung Oh, Anyang-Si (KR); Yun Ho Lee, Anyang-Si (KR); Yon Woo Chung, Seoul (KR)

(73) Assignee: REALGAM CO., LTD., Seongnam-Si, Gyeonggi-do (KR)

(21) Appl. No.: 16/311,019

(22) PCT Filed: Nov. 27, 2018
(86) PCT No.: PCT/KR2018/014687

§ 371 Date: Dec. 18, 2018

(30) Foreign Application Priority Data
Nov. 7, 2018 (KR) 10-2018-0135574

(51) Int. Cl. G06F 3/01

(52) U.S. Cl. CPC G06F 3/016; G06F 3/011

(57) ABSTRACT

Disclosed is a force feedback method. The force feedback method includes setting a user object and a virtual object on an extended reality environment; detecting an event that the user object interacts with the virtual object; changing a force feedback control variable based on a type of the event and a density difference between the user object and the virtual object; and providing kinesthesia through an output apparatus based on the changed force feedback control variable.

### TECHNICAL FIELD

An example embodiment relates to a force feedback method using a density, and more particularly, to a force feedback method and system that may provide kinesthesia by a density difference between a user object and a virtual object.

### RELATED ART

Techniques related to augmented reality, mixed reality, and virtual related are rapidly developing in relation to the fourth industrial revolution. Such augmented reality, mixed reality, and virtual reality are attempting to expand a sense of reality beyond time and space. Accordingly, such technologies are collectively referred to as extended reality.

In general, the extended reality technology is used in a computing system in the fields of education, entertainment, training, and medicine. In particular, the extended reality technology is regarded as an alternative capable of enhancing the sense of reality that is limited in an existing game through combination with the game and is also attracting attention due to the effect as if a user experiences the game.

To add a sense of immersion to the game based on the extended reality technology, a force feedback providing controller that realistically transfers a physical change in an image, such as a collision and a positional change, to a user is being developed. Many controllers according to the related art use a method of applying a vibration. Such a controller using haptic feedback of applying a vibration may provide a sense of immersion, however, may not readily provide a sense of reality due to limit of a sense provided by the vibration. Currently, due to some limitations found in haptic feedback by vibration, a kinesthetic force feedback system that provides a direct force to the user is being developed.

However, many force feedback systems generate force feedback suitable for a specific event through a manual task and, in response to occurrence of an event in a game, calls and executes a corresponding library. Accordingly, kinesthetic force feedback may simply provide kinesthesia by a specific event and may not provide kinesthesia that includes a change in an environmental factor. In particular, realistic representations are gradually increasing in a game and a variety of force feedback needs to be implemented in the same event, which may not be readily achieved with current technology.

### DETAILED DESCRIPTION

### Objectives

An example embodiment provides a force feedback method and system using a density that may generate a force feedback control signal based on a physical control factor of an object and may provide kinesthesia to a user to enhance a sense of reality and a sense of immersion in extended reality.

Also, an example embodiment provides a force feedback method and system using a density that may provide a user with kinesthesia by density in response to an interaction between a user object and a virtual object in an environment using extended reality, such that the user may actually experience a sense in an extended reality environment.

Objectives to be solved in example embodiments are not limited thereto and other objectives not described herein may be clearly understood by those skilled in the art from the following description.

### Solutions

A force feedback method according to an example embodiment is described.

According to an aspect, there is provided a force feedback method including setting a user object and a virtual object on an extended reality environment; detecting an event that the user object interacts with the virtual object; changing a force feedback control variable based on a type of the event and a density difference between the user object and the virtual object; and providing kinesthesia through an output apparatus based on the changed force feedback control variable.

According to another aspect, there is provided a non-transitory computer-readable storage medium recording a program to implement a force feedback method.

According to another aspect, there is provided a force feedback system including a control apparatus configured to detect an event that a user object interacts with a virtual object on an extended reality environment, and to generate a force feedback control signal by changing a force feedback control variable based on a density of the user object and a density of the virtual object; and an output apparatus configured to receive the force feedback control signal and to provide a user with kinesthesia.

### Effect

According to example embodiments, it is possible to further enhance a sense of reality and a sense of immersion in an extended reality environment by generating a force feedback control signal based on a physical control factor of an object and by providing a user with kinesthesia to enhance the sense of reality and the sense of immersion in extended reality.

Also, according to example embodiments, since kinesthesia by density is provided to a user in response to an interaction between a user object and a virtual object in an environment using extended reality, the user may actually experience a physical sense in an extended reality environment.

The effects of the force feedback method and system using the density according to the example embodiments are not limited thereto and other effects not described herein may be clearly understood by those skilled in the art from the following description.

### BRIEF DESCRIPTION OF DRAWINGS

The following drawings attached herein provide the example embodiments and are provided to simply make the technical spirit of the disclosure further understandable with the detailed description and accordingly, should not limit or restrict the present disclosure.

FIG. 1 is a diagram illustrating a force feedback system according to an example embodiment.

FIG. 2 is a diagram illustrating a controller according to an example embodiment.

FIG. 3A illustrates an example of an action of force when a density of a user object is less than that of a virtual object on an extended reality environment.

FIG. 3B illustrates an example of an action of force when a density of a user object is greater than that of a virtual object on an extended reality environment.

FIG. 4 illustrates an example of a change in a force between a user object and a virtual object by a density difference on an extended reality environment according to another example embodiment.

FIG. 5A illustrates an example of locations of a plurality of virtual objects and a user object according to an example embodiment.

FIG. 5B is a graph showing a change in a force vector of FIG. 5A.

FIG. 6A illustrates an example of a user object over a plurality of virtual objects according to an example embodiment.

FIG. 6B is a graph showing a change in a force vector according to the example embodiment of FIG. 6A.

FIG. 7 is a flowchart illustrating a force feedback method according to an example embodiment.

FIG. 8 is a flowchart illustrating a force feedback method according to another example embodiment.

### BEST MODE

Hereinafter, some example embodiments will be described in detail with reference to the accompanying drawings. Regarding reference numerals assigned to elements in the drawings, it should be noted that the same elements will be designated by the same reference numerals, wherever possible, even though they are shown in different drawings. Also, in the description of example embodiments, detailed description of well-known related structures or functions will be omitted when it is deemed that such description will cause ambiguous interpretation of the present disclosure.

Terms, such as first, second, A, B, (a), (b), and the like, may be used herein to describe components. Each of these terminologies is not used to define an essence, order or sequence of a corresponding component but used merely to distinguish the corresponding component from other components. It should be noted that if it is described that one component is “connected”, “coupled”, or “joined” to another component, a third component may be “connected”, “coupled”, and “joined” between the first and second components, although the first component may be directly connected, coupled, or joined to the second component.

A component included in a single example embodiment and a component including a common function are described using the same name in another example embodiment. Unless described otherwise, description made in one example embodiment may be applicable to the other example embodiment and a detailed description in the repeated range is omitted.

Prior to describing the example embodiment, the term “user object U” refers to a body of an actual user, a virtual user body, or an actual or virtual tool gripped or worn by the user, which is implemented in an extended reality environment in response to an input or a motion of the user. Also, the user object U may be implemented in any type of material states, such as liquid, gas, and solid, on extended reality.

Also, the term “virtual object O” refers to a virtual object capable of interacting with the user object U on the extended reality. Here, the virtual object U may be implemented any type of material states, such as liquid, gas, and solid. Also, the virtual object O may be a fluid that encompasses the user object U on the extended reality.

The extended reality collectively refers to augmented reality, mixed reality, and virtual reality.

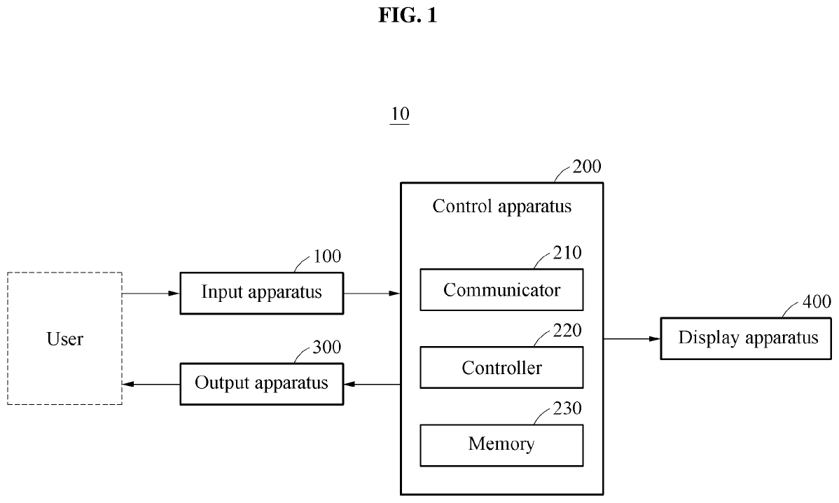

FIG. 1 is a diagram illustrating a force feedback system according to an example embodiment.

Referring to FIG. 1, a force feedback system 10 includes an input apparatus 100, a control apparatus 200, an output apparatus 300, and a display apparatus 400. Although not illustrated, the force feedback system 10 may further include a camera and a microphone.

The input apparatus 100 may refer to an apparatus configured to receive information on a location, a direction, an acceleration, a pressure, and a key corresponding to an input of a user and to generate input data. The input apparatus 100 may be an apparatus that includes a gyro sensor, an encoder, a touch panel, and a keypad with a plurality of key buttons, and is configured to detect the input of the user and generate the input data. For example, the input apparatus 100 may be a game pad, a paddle controller, a trackball, a joystick, an arcade style joystick, a vehicle handle, a mouse, and a data glove. Also, the input apparatus 100 may be configured as, for example, a camera and a motion sensor, configured to detect a motion such as a hand motion and an arm motion of the user and to recognize the motion as the input of the user.

The control apparatus 200 may be an apparatus that includes a storage medium in which a physical engine configured to generate and provide an extended reality environment is recorded. For example, the control apparatus 200 may be a computer, a portable communication terminal such as a cellular phone, a console, a personal digital assistant (PDA), a tablet personal computer (PC), and a server, including a storage medium in which a physical engine is recorded. The control apparatus 200 includes a communicator 210, a controller 220, and a memory 230.

The control apparatus 200 provides an extended reality environment, detects an event that a user object U interacts with a virtual object O, changes a force feedback control variable, and generates a force feedback control signal for providing kinesthesia.

The communicator 210 may transmit and receive input data, a force feedback control signal, image data, and audio data through communication with the input apparatus 100, the output apparatus 300, or the display apparatus 400. The communicator 210 may communicate with the input apparatus 100, the output apparatus 300, or the display apparatus 400 in a wired manner using, for example, a local area network (LAN) and a data cable, or in a wireless manner using, for example, radio frequency (RF) communication, wireless fidelity (WiFi), long term evolution (LTE), Bluetooth, infrared data association (IrDA), ZigBee, ultrawideband (UWB), code division multiple access (CDMA), frequency division multiplexing (FDM), and time division multiplexing (TDM). Also, the communicator may communicate with the input apparatus 100, the output apparatus 300, or the display apparatus 400 by connecting to the Internet.

Here, the input apparatus 100, the output apparatus 300, or the display apparatus 400 may include a communication module (not shown) capable of communicating with the communicator 210. The communication module may communicate with the communicator 210 in the same manner or may connect thereto through the Internet.

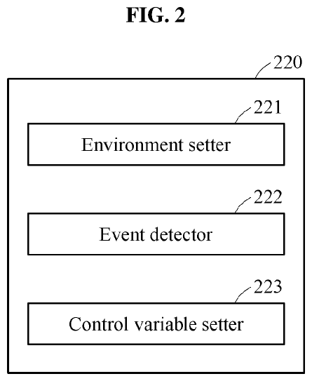

The controller 220 executes a program or an application of providing an extended reality environment, such as a game, in response to a selection of the user, detects the event and changes a force feedback control variable on the extended reality environment, and generates a force feedback control signal according thereto. Further description related to the controller 220 will be made with reference to FIG. 2.

The memory 230 may store applications of various functions such as a game and a communication, images for providing graphical user interfaces (GUIs) associated therewith, user information, document related databases, background images, for example, a menu screen and an idle screen, or operation programs required to operate the force feedback system, and the like. Also, the memory 230 may store data of a force feedback control variable corresponding to each of control factors. Here, the memory 230 may store force feedback control variable data according to density among control factors, and may pre-store data on a change in the density of the user object U and the density of the virtual object O based on an environmental characteristic including one of mixing, a pressure, an attracting force, a repulsive force, and a temperature of the virtual object O.

Also, the control factors refer to factors indicating physical characteristics for representing the user object U, the virtual object O, and the event, and include density, a magnitude of force, a contact angle, a contact area, a stiffness, a friction coefficient, and a viscosity. The control factor may be the same factor as a characteristic in actual reality, or may be a factor arbitrarily set by the user. Here, the control factor represents a physical characteristic of the user object U or the virtual object O and is not construed as being limited to the aforementioned configuration.

The force feedback control variable refers to a variable for providing force feedback. For example, in the case of a force feedback control through an impedance control, the force feedback control variable may be a mass constant m, an attenuation constant c, or a spring constant k.

The output apparatus 300 is a kinesthesia-type output apparatus that provides a physical force. The output apparatus 300 receives the force feedback control signal, and provides the received force feedback control signal to the user as kinesthesia. The output apparatus 300 provides a magnitude, a direction, and an angle of force, so that the user may experience a sense of reality.

Also, desirably, the output apparatus 300 may be an output apparatus that may output a delicate change in force through freewheeling in which load by a motor is absent since the output apparatus 300 includes a clutch among kinesthesia-type output apparatuses and a connection to a driving portion such as the motor is completely blocked. If the kinesthesia-type output apparatus capable of performing freewheeling may be configured in three states, for example, a load state of an output shaft by an operation of the motor, a no-load state by a magnetic field of the motor through connection between the output shaft and the motor, and a freewheeling state, it may be the most desirable form.

Although the input apparatus 100 and the output apparatus 300 are illustrated to be separate herein, it is provided as an example only for clarity of description. The input apparatus 100 and the output apparatus 300 may be provided in an integrated form and input and output may be performed in a single apparatus.

The display apparatus 400 displays the image data and the audio data received from the control apparatus 200 for the user. For example, the display apparatus 400 may be a TV including a display and a speaker, a monitor, and a head mounted display (hereinafter, a VR headset). The display apparatus 400 may display, for the user, an image updated periodically or in response to an event.

The force feedback system 10 may output, as kinesthesia, action/reaction, touch, a repulsive force, and a resistance occurring by interaction with the virtual object, such as contact, collision, striking, passing, and penetration, in the extended reality, and may provide the kinesthesia to the user. Also, the force feedback system 10 may provide the user with a sense that the user experiences based on an attracting force or a repulsive force set in the extended reality or a sense that the user experiences while interacting with the virtual object in the extended reality.

FIG. 2 is a diagram illustrating a controller according to an example embodiment.

Referring to FIG. 2, the controller 220 includes an extended reality provider 221, an event detector 222, and a control variable setter 223.

The extended reality provider 221 configures extended reality including user object data and virtual object data. For example, the extended reality provider 221 may generate the user object U, the virtual object O, and the control factor into data, and thereby generate and provide an extended reality environment. Also, the extended reality provider 221 may generate the extended reality environment by setting an environmental characteristic including at least one of a pressure, an attracting force, a repulsive force, and a temperature on the extended reality. Also, the extended reality provider 221 may provide virtual reality and may arbitrarily implement an environmental characteristic, and may implement the virtual reality to be similar to the reality. For example, the extended reality provider 221 may generate an environment in which a plurality of attracting forces or repulsive forces are present.

The extended reality provider 221 may generate the generated extended reality environment into image data and audio data, and may provide the generated image data and audio data to the display apparatus 400 through the communicator 210, such that the user may receive the same using an image and sound. Also, the extended reality provider 221 may provide the display apparatus 400 with image data and audio data that is updated in response to an event in real time.

The user object data refers to data that includes a physical control factor of the user object U in the extended reality. Also, the virtual object data refers to data that includes a physical control factor of the virtual object O in the extended reality. Here, all of the user object U and the virtual object O may be configured as virtual objects. At least one thereof may be configured as a hologram or a virtual object in the extended reality.

The event detector 222 detects the event by determining an interaction event between the user object and the virtual object. For example, the event detector 222 may detect the interaction by a density difference between the user object U and the virtual object O in response to a user input or a process being executed, or may detect an instruction of the user input causing the interaction by the density difference between the user object and the virtual object. The event detector 222 detects the event, generates event data, and transfers the generated event data to the control variable setter 223. Here, the interaction may indicate, for example, mixing of a plurality of virtual objects or an action of force by a physical factor difference between the virtual object O and the user object U since the user object U contacts with, inserts into, penetrates into, escapes from, or passes through the virtual object, or since the user object is positioned within the virtual object.

For example, the interaction may be an action of force by the density difference between the user object U and the virtual object O. The event detector 222 detects the interaction event occurring due to the density difference between the user object and the virtual object, generates event data, and transfers the generated event data to the control variable setter 223.

The control variable setter 223 receives the event data and changes a force feedback control variable. Here, the control variable setter 223 changes the force feedback control variable to provide a sense, that is, kinesthesia that the user may actually experience by the density difference between the user object U and the virtual object O, based on a location of the input apparatus 100 of the user.

The control variable setter 223 extracts physical control factor information from user object data, virtual object data, and event data, and changes the force feedback control variable. The control variable setter 223 changes force feedback by using the density as the physical control factor. Also, the control variable setter may change the force feedback control variable by further including at least one of control factors including a contact angle between the user object U and the virtual object O, a contact area between the user object U and the virtual object O, a stiffness of the user object U, a friction coefficient of the user object U, a friction coefficient of the virtual object O, a viscosity of the user object U, a viscosity of the virtual object O, and flow of the virtual object O. The control variable setter 223 determines a direction or an angle of kinesthesia based on a direction in which an attracting force or a repulsive force acts on the extended reality environment, and changes the force feedback control variable.

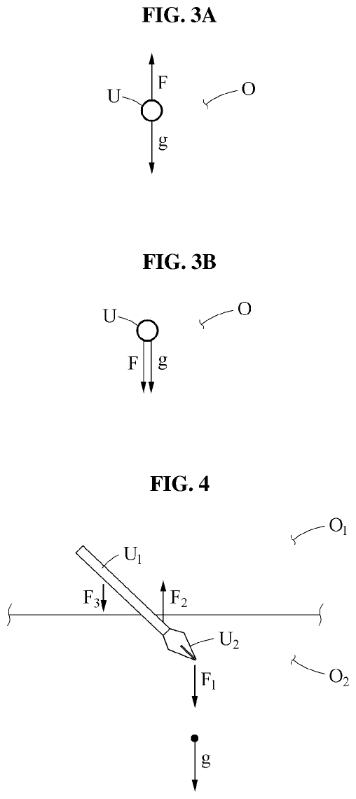

FIGS. 3A and 3B illustrate examples of a change in force between a user object and a virtual object by a density difference on an extended reality environment according to an example embodiment. Here, FIG. 3A illustrates an example of an action of force when a density of the user object is less than that of the virtual object on the extended reality environment, and FIG. 3B illustrates an example of an action of force when a density of the user object is greater than that of the virtual object on the extended reality environment.

Referring to FIG. 3A, when the density of the user object U is less than that of the virtual object O, a force acting on the user object U is generated in a direction opposite to gravity due to an interaction between the user object U and the virtual object O. Referring to FIG. 3B, when the density of the user object U is greater than that of the virtual object O, a force acting in the user object is generated in a direction of gravity due to the interaction between the user object U and the virtual object O. Here, the control variable setter 223 may determine a direction of kinesthesia and a magnitude of kinesthesia by changing a force feedback control variable based on a direction and a magnitude of an attracting force or a repulsive force acting in the user object U and a density difference between the user object U and the virtual object O. For example, the control variable setter 223 changes the force feedback control variable to increase the magnitude of kinesthesia according to an increase in the density difference. Also, the control variable setter changes the force feedback control variable to increase the magnitude of kinesthesia when the magnitude of gravity is great.

On the extended reality environment, the user object U moves due to the density difference between the user object U and the virtual object O. Here, the control variable setter 223 may change the force feedback control variable based on at least one of control factors including a contact angle between the user object U and the virtual object O, a contact area between the user object U and the virtual object O, a stiffness of the user object U, a friction coefficient of the user object U, a friction coefficient of the virtual object O, a viscosity of the user object U, a viscosity of the virtual object O, and a flow of the virtual object O. The control variable setter 223 may provide the user with kinesthesia by the density difference and may further provide the user with kinesthesia with the virtual object O by movement of the user object U.

For example, it may be assumed that the user object U is a tube and the virtual object O is water. Here, when the user puts the tube into the water on the extended reality, the water pushes away the tube by a density difference between the water and the tube. Here, although the tube is pushed away from the water due to the density difference, a force is partially offset due to a surface friction and a viscosity of the tube and a friction and a viscosity of the water.

Also, when the user object U is a metal object and the virtual object O is water, the user object U penetrates deeper into the water due to the density difference. Here, a force acting in the user object U may be partially offset due to the density difference by the friction and the viscosity. Here, the control variable setter 223 may provide realistic kinesthesia by changing the force feedback control variable based on all of the physical control factors acting on the tube.

FIG. 4 illustrates an example of a change in a force between a user object and a virtual object by a density difference on an extended reality environment according to another example embodiment.

Referring to FIG. 4, the control variable setter 223 changes a force feedback control variable by adding up a force vector with respect to a density difference between each of a user object parts U1 and U2 each having a different density and a virtual object O1, O2. Also, the control variable setter 223 changes the force feedback control variable by adding up a force vector occurring due to a density difference between the user object U1, U2 and each of the virtual object O1 and the other virtual object O2 when the user object U1, U2 is positioned over one virtual object O1 of the plurality of virtual objects O1 and O2 and the other virtual object O2. Also, the control variable setter 223 may change the force feedback control variable by adding up density differences according to combinations between the plurality of user object parts U1 and U2 and the plurality of virtual objects O1 and O2.

The user objects U1 and U2 may be provided as the plurality of user object parts U1 and U2 each having a different density on the extended reality. The user objects U1 and U2 may be a harpoon that includes a harpoon rod U1 having a density less than that of water O2 and a metal tip U2 having a density greater than that of the water O2. Also, a plurality of virtual objects O may be provided. For example, the virtual objects O1 and O2 may include air O1 and the water O2.

When a portion of the metal tip U2 and the harpoon rod U1 corresponding to the user objects U1 and U2 are immersed into the water O2, a first force F1 acts on the metal tip U2 in a direction of gravity and a second force F2 acts on the harpoon rod U1 in a direction opposite to the gravity. Here, a third force F3 acts on the harpoon rod U1 that is not immersed in the water O2, in the direction of gravity. Here, the control variable setter 223 may change the force feedback control variable by adding up force vectors of the first force F1, the second force F2, and the third force F3.

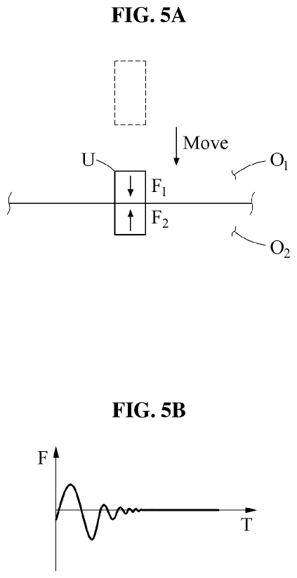

FIGS. 5A and 5B illustrate examples of a change in a force acting on a user object based on a change in a density of a virtual object according to another example embodiment. Here, FIG. 5A illustrates an example of locations of a plurality of virtual objects and a user object according to an example embodiment, and FIG. 5B is a graph showing a change in a force vector of FIG. 5A.

Referring to FIGS. 5A and 5B, when a plurality of virtual objects is mixed, the control variable setter 223 calculates a density of the plurality of virtual objects according to mixing of the plurality of virtual objects and changes a force feedback control variable based on a difference between the calculated density of the plurality of virtual objects and a density of the user object.

For example, the user object U generated by the extended reality provider 221 may have a density less than that of a first virtual object O1 and greater than that of a second virtual object O2. An initial location of the user object U may be in the first virtual object O1. Here, the extended reality provider 221 may set an attracting force in a direction from the second virtual object O2 toward the first virtual object O1.

Here, the first virtual object O1 generated by the extended reality provider 221 may be water and the second virtual object O2 may be air. When salt that is another virtual object is mixed in the water in a state in which the user object U is immersed in the water that is the first virtual object O1, the first virtual object O1 may be generated as salt water and a density thereof increases. Here, if the user object U has a density greater than that of the water and less than that of the salt water, the user object U moves since a force acts in a direction opposite to the attracting force. According to an increase in the density of salt in the salt water, the first virtual object O1 may receive a greater force and may move toward the second virtual object.

When the plurality of virtual objects is mixed, the control variable setter 223 calculates a density of the plurality of virtual objects according to a mixing ratio of the plurality of virtual objects and changes the force feedback control variable according to a difference between the calculated density of virtual objects and the density of the user object U. Here, the control variable setter may calculate a density of the mixed salt water or fetch density data from the memory, and may change the force feedback control variable based on the density difference with the user object.

The user object U may reciprocally move between the first virtual object O and the second virtual object O due to the first force F1 and the second force F2 by the density difference, and may enter in an equilibrium state as the force is gradually attenuated.

The extended reality provider 221 may set a pressure or a temperature in the extended reality. In this case, the density of the user object U or the virtual object O may vary. For example, in the extended reality, the user object U may be a hot-air balloon and the virtual object O may be air. Here, the extended reality provider 221 may cause a density change event of the user object U by setting a temperature of the hot-air balloon to be high. A force acts on the user object U in a direction opposite to the gravity based on a change in the density by the temperature difference. The control variable setter 223 may change the force feedback control variable by using, as a control factor, the density difference that varies based on an environmental characteristic of the extended reality, and may provide realistic kinesthesia.

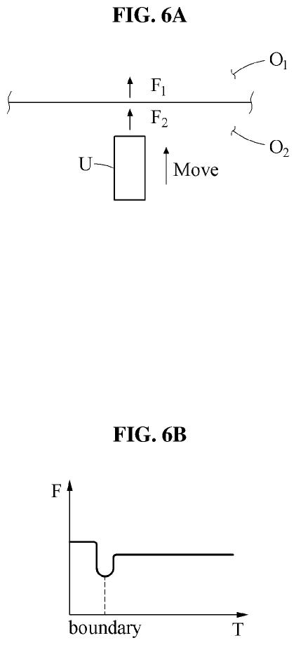

FIGS. 6A and 6B illustrate examples of a change in a force of a user object acting on a boundary surface between virtual objects. Here, FIG. 6A illustrates an example of the user object over the plurality of virtual objects according to an example embodiment, and FIG. 6B is a graph showing a change in a force vector according to the example embodiment of FIG. 6A.

Referring to FIG. 6, a density of a user object U is set to be less than those of a first virtual object O1 and a second virtual object O2. Also, the density of the first virtual object O1 is set to be less than that of the second virtual object O2. An attracting force acts in a direction from the first virtual object O1 toward the second virtual object O2.

The user object U moves in a direction from the second virtual object O2 toward the first virtual object O1 due to a density difference. Here, when a density difference between the first virtual object O1 and the second virtual object O2 is insignificant, the user may not recognize a change in the boundary. Here, the control variable setter 223 may change a control variable to instantaneously increase or decrease kinesthesia in a boundary between the virtual objects O1 and O2, such that the user may certainly recognize a sense for the change in the boundary.

The control variable setter 223 sets a control variable for any one of an open loop control method, an ON/OFF control method, a PID control method, and an impedance control method. However, it is provided as an example only. Any method capable of providing a writing pressure may be applied.

For example, the control variable setter 223 changes an impedance control variable based on a magnitude and a direction of kinesthesia and a control factor. Here, the impedance control variable may include a spring constant k, a mass constant m, and an attenuation constant c. The control variable setter 223 may determine kinesthesia to be provided to the output apparatus 300 by changing the attenuation constant c based on a friction coefficient or a viscosity or by changing the spring constant k and the mass constant m based on the magnitude and the direction of kinesthesia, and generates a force feedback control signal and provides the generated force feedback control signal to the output apparatus 300.

Also, the control variable setter 223 may change a control variable to be suitable for each control method. For example, the control variable setter 223 may change a control variable based on a control factor according to a control method of the output apparatus 300. That is, the control variable setter 223 may generate a control signal based on data of the memory according to each of different control methods of the output apparatus 300, and may generate a force feedback control signal for the kinesthesia and may provide the generated force feedback control signal.

The control variable setter 223 may provide force feedback to the user through the output apparatus by providing the force feedback control signal to the output apparatus through the communicator.

The controller 220 may generate and provide a force feedback control signal for kinesthesia based on density, such that the user may experience a sense of reality. Also, the controller 220 may change a control variable based on a real-time change in an event and may provide the user with kinesthesia varying in real time. The force feedback system 10 may be applied to various applications and programs that require providing of writing pressure according to a change in the event.

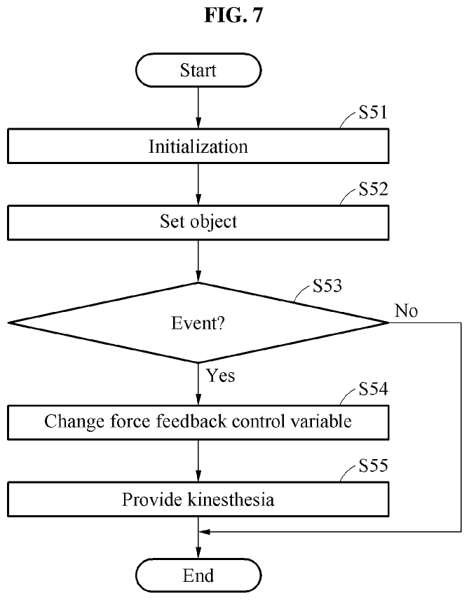

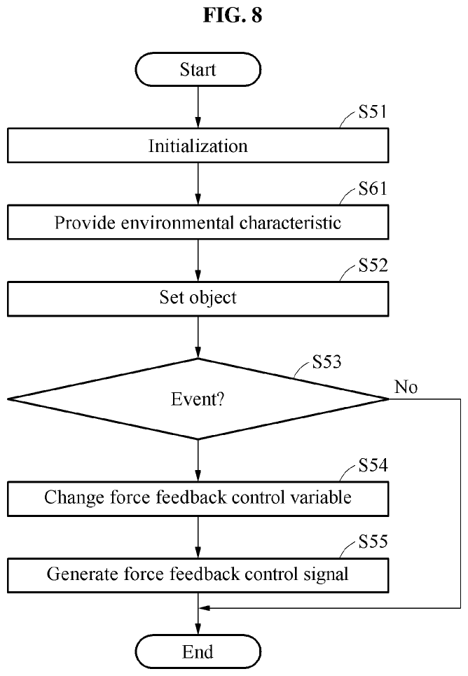

Hereinafter, a force feedback method using the force feedback system 10 according to an example embodiment will be described with reference to FIGS. 7 and 8.

FIG. 7 is a flowchart illustrating a force feedback method according to an example embodiment.

Referring to FIG. 7, the force feedback method includes operation S51 of performing initialization, operation S52 of setting an object, operation S53 of detecting an event, operation S54 of changing a force feedback control variable, and operation S55 of providing kinesthesia.

In operation S51 of performing initialization, the extended reality provider 221 generates a user object U and a virtual object O by loading an application or a program.

In operation S52 of setting an object, the extended reality provider 221 sets the user object and the virtual object on the extended reality environment. For example, the extended reality provider 221 extracts a control factor including a density stored in the memory 230, and applies and thereby set the extracted control factor to user object data and virtual object data.

In operation S53 of detecting an event, the event detector 222 detects an interaction event between the user object and the virtual object. Here, the event detector 222 generates event data that includes input data, user object data, and virtual object data. The event detector 222 transmits the event data to the control variable setter 223 by further including at least one of a progress direction, a moving speed, acceleration, a magnitude of force, and a direction of force according to the input of the user. Here, the interaction may indicate, for example, mixing of a plurality of virtual objects or an action of force by a physical factor difference between the virtual object and the user object since the user object U contacts with, inserts into, penetrates into, escapes from, or passes through the virtual object, or since the user object is positioned within the virtual object.

In operation S54 of changing a force feedback control variable, the control variable setter 223 changes the force feedback control variable based on the user object data, the virtual object data, and the event data. The control variable setter 223 may change the force feedback control variable based on the control factor including the density. Here, the control factor aside from the density may include at least one of a contact angle between the user object and the virtual object, a contact area between the user object and the virtual object, a stiffness of the user object, a friction coefficient of the user object, a friction coefficient of the virtual object, a viscosity of the user object, a viscosity of the virtual object, and a flow of the virtual object.

The control variable setter 223 provides force feedback about a force occurring due to a density difference between the user object U and the virtual object O. For example, when the user object has a density less than that of the virtual object, the control variable setter 223 provides force feedback in a direction opposite to a direction in which an attracting force or a repulsive force acts. Here, the control variable setter determines a direction or an angle of kinesthesia based on the direction in which the attracting force or the repulsive force acts on the extended reality environment.

In response to occurrence of an event that the plurality of virtual objects is mixed, the control variable setter 223 calculates a density of the plurality of virtual objects according to mixing of the plurality of virtual objects and changes the force feedback control variable based on the calculated density of the plurality of virtual objects and the density of the user object.

When the user object U includes a plurality of user object parts each having a different density, the control variable setter 223 changes the force feedback control variable by adding up a force vector with respect to a density difference between each of the plurality of user object parts each having the different density and the virtual object. Also, in response to detecting an event that the user object is positioned over another virtual object having a density different from that of the virtual object in operation S53, the control variable setter changes the force feedback control variable based on a force vector occurring due to a density difference between the user object and each of the virtual object and the other virtual object.

Also, in response to detecting an event that the user object moves from the virtual object to the other object having the different density in operation S53, the control variable setter 223 changes the force feedback control variable to instantaneously increase or decrease a magnitude of force feedback in a boundary between the virtual object and the other virtual object.

The control variable setter 223 sets a control variable based on a control method of the output apparatus 300. For example, when the control method of the output apparatus 300 is an impedance control method, the control variable setter 223 sets a control variable, for example, a spring constant k, a mass constant m, and an attenuation constant c, based on at least one of control factors including a magnitude of force, a contact angle, a contact area, a stiffness, a friction coefficient, and a viscosity. Also, the control variable setter 223 sets a direction and a magnitude of force feedback of the output apparatus 300 based on a progress direction, a moving speed, acceleration, a magnitude of force, and a direction of force.

In operation S55 of providing kinesthesia, the control variable setter 223 generates a force feedback control signal based on the force feedback control variable and transfers the control signal to the output apparatus 300 to output the kinesthesia.

Although not illustrated, the force feedback method may further include an operation of providing the user with an image that is updated in response to the event.

The force feedback method outputs the kinesthesia in real time by iteratively performing the aforementioned process.

FIG. 8 is a flowchart illustrating a force feedback method according to another example embodiment.

Referring to FIG. 8, the force feedback method includes operation S51 of performing initialization, operation S61 of providing an environmental characteristic, operation S52 of setting an object, operation S53 of detecting an event, operation S54 of changing a force feedback control variable, and operation S55 of providing kinesthesia.

Although not illustrated, the force feedback method may further include an operation of providing a user with an image that is updated in response to an event.

Here, operation S51 of performing initialization, operation S52 of setting an object, operation S53 of detecting an event, and operation S55 of providing kinesthesia include the same components as those in the force feedback method of FIG. 7. Accordingly, a further description related thereto is omitted.

In operation S61 of providing an environmental characteristic, the extended reality provider 221 provides an environmental characteristic including one of a pressure, an attracting force, a repulsive force, and a temperature around the user object or the virtual object O in the extended reality.

Here, in operation S54 of changing a force feedback control variable, the control variable setter 223 changes a force feedback control variable in response to a change in density of the user object U or the virtual object O occurring due to the provided environmental characteristic. For example, the density of the virtual object O may vary based on the temperature and the pressure. Here, the control variable setter 223 may change the force feedback control variable by adding up or subtracting the density of the virtual object O based on the temperature and the pressure, and may realistically provide the kinesthesia to the user.

The force feedback method according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although a number of example embodiments have been described above, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A force feedback method comprising:
setting a user object and a virtual object on an extended reality environment;
detecting an event that the user object interacts with the virtual object;
changing a force feedback control variable based on a type of the event and a density difference between the user object and the virtual object; and
providing kinesthesia through an output apparatus based on the changed force feedback control variable.

2. The force feedback method of claim 1, wherein the changing of the force feedback control variable comprises changing a direction or an angle of the kinesthesia based on a direction in which a attracting force or a repulsive force acts on the extended reality environment.

3. The force feedback method of claim 1, wherein the setting of object comprises configuring the user object using a plurality of user object parts each having a different density, and
the changing of the force feedback control variable comprises changing the force feedback control variable by adding up a force vector with respect to a density difference between each of the plurality of user object parts each having the different density and the virtual object.

4. The force feedback method of claim 1, wherein, in response to detecting an event that the user object is positioned over another virtual object having a density different than that of the virtual object in the detecting of the event, the changing of the force feedback control variable comprises changing the force feedback control variable based on a force vector occurring due to a density difference between the user object and each of the virtual object and the other virtual object.

5. The force feedback method of claim 4, wherein, in response to detecting an event that the user object moves from the virtual object to the other virtual object having the different density in the detecting of the event, the changing of the force feedback control variable comprises changing the force feedback control variable to instantaneously increase or decrease a magnitude of force feedback in a boundary between the virtual object and the other virtual object.

6. The force feedback method of claim 1, wherein, in response to detecting an event that a plurality of virtual objects is mixed in the detecting of the event, the changing of the force feedback control variable comprises:
calculating a density of the plurality of virtual objects according to mixing of the plurality of virtual objects; and
changing the force feedback control variable based on the calculated density of the plurality of virtual objects and a density of the user object.

7. The force feedback method of claim 1, wherein, in response to detecting an event that the user object moves in the detecting of the event, the changing of the force feedback control variable comprises changing the force feedback control variable by further comprising at least one of control factors comprising a contact angle between the user object and the virtual object, a contact area between the user object and the virtual object, a stiffness of the user object, a friction coefficient of the user object, a friction coefficient of the virtual object, a viscosity of the user object, a viscosity of the virtual object, and a flow of the virtual object.

8. The force feedback method of claim 1, further comprising:
providing an environmental characteristic that comprises one of a pressure, a attracting force, a repulsive force, and a temperature around the user object or the virtual object,
wherein the changing of the force feedback control variable comprises changing the force feedback control variable in response to a change in a density of the user object or the virtual object by the environmental characteristic.

9. The force feedback method of claim 1, further comprising:
providing a user with an image that is updated in response to the event.

10. A force feedback system comprising:
a control apparatus configured to detect an event that a user object interacts with a virtual object inter on an extended reality environment, to change a force feedback control variable based on a density of the user object and a density of the virtual object, and to generate a force feedback control signal; and
an output apparatus configured to receive the force feedback control signal and to provide a user with kinesthesia.

11. The force feedback system of claim 10, wherein the user object comprises a plurality of user parts each having a different density, and
the control apparatus is configured to change the force feedback control variable by adding up a force vector with respect to a density difference between each of the plurality of user object parts each having the different density and the virtual object

12. The force feedback system of claim 10, wherein the control apparatus is configured to determine a direction or an angle of the kinesthesia based on a direction in which a attracting force or a repulsive force acts on the extended reality environment.

13. The force feedback system of claim 10, wherein a plurality of virtual objects is provided, and
the control apparatus is configured to change the force feedback control variable by adding up a force vector occurring due to a density difference between the user object and each of one virtual object of the plurality of virtual objects and another virtual object when the user object is positioned over the one virtual object and the other virtual object.

14. The force feedback system of claim 10, wherein a plurality of virtual objects is provided, and
the control apparatus is configured to change the force feedback control variable to instantaneously increase or decrease a magnitude of force feedback in a boundary between one virtual object of the plurality of virtual objects and another virtual object when the user object moves from the one virtual object to the other virtual object.

15. The force feedback system of claim 10, wherein a plurality of virtual objects is provided, and
the control apparatus is configured to calculate a density of the plurality of virtual objects according to mixing of the plurality of virtual objects and to change the force feedback control variable based on a difference between the calculated density of the plurality of virtual objects and the density of the user object when the plurality of virtual objects is mixed.

16. The force feedback system of claim 10, wherein the control apparatus is configured to change the force feedback control variable based on at least one of control factors comprising a contact angle between the user object and the virtual object, a contact area between the user object and the virtual object, a stiffness of the user object, a friction coefficient of the user object, a friction coefficient of the virtual object, a viscosity of the user object, and a viscosity of the virtual object when the user object moves.

17. The force feedback system of claim 16, further comprising:
an input apparatus configured to detect an input of the user,
wherein the user object moves on the extended reality environment in response to the user of the user.

18. The force feedback system of claim 10, wherein the control apparatus is configured to change the force feedback control variable in response to a change in the density of the user object and the density of the virtual object by an environmental characteristic that comprises one of a pressure, a attracting force, a repulsive force, and a temperature around the user object or the virtual object.

19. The force feedback system of claim 10, further comprising:
a display apparatus configured to provide the user with an image that is updated in response to the event.
